(19) United States
(12) Patent Application Publication
(10) Pub. No.: US 2009/0071936 A1
(43) Pub. Date: Mar. 19, 2009

(54) METHOD OF MANUFACTURING INKJET PRINTHEAD AND INKJET PRINTHEAD MANUFACTURED USING THE SAME

(75) Inventors: Byung-ha PARK, Suwon-si (KR); Young-ung Ha, Suwon-si (KR); Sung-joon Park, Suwon-si (KR); Jeong-wuk Han, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/193,086

(22) Filed: Aug. 18, 2008

(30) Foreign Application Priority Data
Sep. 19, 2007 (KR) 2007-95448

(51) Int. Cl. B44C 1/22; B41J 2/04

(52) U.S. Cl. 216/27; 347/54

(57) ABSTRACT

A method of manufacturing an inkjet printhead using a channel forming material, in which a glue layer to enhance an adhesive force between a substrate and a channel forming layer is not required.

### CROSS-REFERENCE TO RELATED APPLICATIONS

This application claims priority under 35 U.S.C. §119(a) from Korean Patent Application No. 10-2007-0095448, filed on Sep. 19, 2007, in the Korean Intellectual Property Office, the disclosure of which is incorporated herein in its entirety by reference.

### BACKGROUND OF THE INVENTION

1. Field of the Invention

The present general inventive concept relates to a method of manufacturing an inkjet printhead and an inkjet printhead manufactured using the method, and more particularly, to a simple method of manufacturing an inkjet printhead using a channel forming material, in which a glue layer to enhance an adhesive force between a substrate and a channel forming layer is not required, and an inkjet printhead manufacturing using the method.

2. Description of the Related Art

Inkjet printheads eject tiny droplets of printing ink to a predetermined portion of a to-be-printed target sheet so as to produce a predetermined color image. Inkjet printheads can be categorized into thermally driven inkjet printheads and piezoelectric driven inkjet printheads according to an ejection mechanism of ink droplets employed. As for thermally driven inkjet printheads, ink droplets are ejected by an expansion force of bubbles formed when a heat source is applied to ink expand. With regards to piezoelectric driven inkjet printheads, ink droplets are ejected when a pressure generated by deformation of a piezoelectric device is applied to ink. However, thermally driven inkjet printheads and piezoelectric driven inkjet printheads are operated using the principle that ink droplets are ejected by a predetermined energy, and only a method of ejecting ink differs in the two above mentioned types of inkjet printheads.

FIG. 1 is a cross-sectional view illustrating a conventional thermally driven inkjet printhead.

Referring to FIG. 1, the conventional thermally driven inkjet printhead includes a substrate 10, a channel forming layer 20 formed on the substrate 10, and a nozzle layer 30 formed on the channel forming layer 20. The substrate 10 has an ink feed hole 51, and the channel forming layer 20 has an ink chamber 53 that can be filled with ink and a restrictor 52 connecting the ink chamber 53 to the ink feed hole 51. The nozzle layer 30 has at least one nozzle 54 through which ink is ejected from the ink chamber 53. On the substrate 10, at least one heater 41 is mounted to heat ink in the ink chamber 53 and at least one electrode 42 is mounted to supply a current to the heater 41.

An ink droplet ejection mechanism of the conventional thermally driven inkjet printhead will now be described in detail. Ink is fed into the ink chamber 53 through the ink feed hole 51 and the restrictor 52. The ink filled into the ink chamber 53 is then heated by the heater 41 formed of a resistance heating material and located in the ink chamber 53. Once the ink boils, ink bubbles are formed, and the formed ink bubbles expand to generate pressure that is to be applied to the ink filled into the ink chamber 53. Therefore, the ink in the ink chamber 53 is ejected out of the ink chamber 53 through the nozzles 54 in a form of droplets.

US 2007/0017894 discloses a method of manufacturing an inkjet printhead; the method includes a flow path wall forming operation of forming flow path walls on a substrate having energy generating elements formed thereon, an imbedded material depositing operation of depositing an imbedded material between the flow path walls and on a top of each flow path wall, a flattening operation of polishing a top of the deposited imbedded material, until the top of the flow path wall is exposed, and a operation of forming an orifice plate on the tops of the polished imbedded material and the exposed flow path wall. However, when a liquid pathway forming element that is used to form ink channels and ink outlets is formed of a photoresist resin, a glue layer formed of a polyethylene amide resin is employed to enhance an adhesive force between the liquid pathway forming element and a silicon substrate.

Due to use of the glue layer, the method further includes coating a glue layer formed of a polyethylene amide resin on a substrate, forming channel walls on the glue layer positioned with respect to an energy generation device, and patterning the glue layer by etching the glue layer using the channel walls as a mask. The entire manufacturing process is complex and expensive.

### SUMMARY OF THE INVENTION

The present general inventive concept provides a simple method of manufacturing an inkjet printhead using an excellent channel forming material, in which a glue layer to enhance an adhesive force between a substrate and a channel forming layer is not used.

The present general inventive concept also provides an inkjet printhead manufactured using the method.

Additional aspects and utilities of the present general inventive concept will be set forth in part in the description which follows and, in part, will be obvious from the description, or may be learned by practice of the general inventive concept.

The foregoing and/or other aspects and utilities of the general inventive concept may be achieved by providing method of manufacturing an inkjet printhead, in which the method including forming a heater to heat ink, and an electrode to supply a current to the heater, on a substrate, forming a channel forming layer to define an ink channel by coating a first negative photoresist composition on the substrate on which the heater and the electrode are formed and then patterning the coated composition using a photolithography process, forming a sacrificial layer on the substrate on which the channel forming layer is formed such that the sacrificial layer covers the channel forming layer, planarizing top surfaces of the channel forming layer and sacrificial layer using a polishing process, forming a nozzle layer having a nozzle by coating a second negative photoresist composition on the channel forming layer and the sacrificial layer and patterning the coated composition using a photolithography process, forming an ink feed hole in the substrate, and removing the sacrificial layer, wherein each of the first and second negative photoresist compositions includes a prepolymer having a monomer repeating unit which has one of a glycidyl ether functional group, a glycidyl ether functional group and an oxythane functional group, and one of phenol novolac resin-based backbone, bisphenol-A-based backbone, bisphenol-F-based backbone, and alicyclic backbone, a cationic photo initiator, a solvent, and an adhesion promoter.

The foregoing and/or other aspects and utilities of the general inventive concept may also be achieved by providing an inkjet printhead including a substrate, and a channel forming layer directly formed on the substrate without a glue layer formed therebetween, wherein a negative photoresist composition having an adhesion promoter to improve an adhesive force of the channel forming layer with respect to the substrate is used to form the channel forming layer.

The foregoing and/or other aspects and utilities of the general inventive concept may also be achieved by providing a method of manufacturing an inkjet printhead, the method including forming a channel forming layer on a substrate to define an ink channel by coating a first negative photoresist composition on the substrate, and forming a nozzle layer having a nozzle by coating a second negative photoresist composition on the channel forming layer, wherein each of the first and second negative photoresist compositions includes an adhesive promoter so that a glue layer is not used between the substrate and the channel forming layer.

### BRIEF DESCRIPTION OF THE DRAWINGS

The above and other features and utilities of the present general inventive concept will become more apparent by describing in detail exemplary embodiments thereof with reference to the attached drawings in which:

FIG. 1 is a cross-sectional view illustrating a conventional thermally driven inkjet printhead;

FIGS. 2A-2L are cross-sectional views illustrating a method of manufacturing an inkjet printhead, according to an embodiment of the present general inventive concept;

FIG. 3 illustrates an optical microscopic image of a pattern formed on a silicon substrate using a photoresist composition used in a method of manufacturing an inkjet printhead according to an embodiment of the present general inventive concept;

FIG. 4 illustrates an optical microscopic image of a pattern of a channel forming layer on a main substrate according to an embodiment of the present general inventive concept.

FIG. 5 illustrates a scanning electron microscopic (SEM) image of a cross section of a channel forming layer of an inkjet printhead according to an embodiment of the present general inventive concept; and

FIG. 6 illustrates a SEM image of a cross section of a channel forming layer of a conventional inkjet printhead including a glue layer.

### DETAILED DESCRIPTION OF THE PREFERRED EMBODIMENTS

The present general inventive concept may be embodied in many different forms and should not be construed as being limited to the embodiments set forth herein; rather, these embodiments are provided so that this disclosure will be thorough and complete, and will fully convey the concept of the general inventive concept to those skilled in the art. In the drawings, the thicknesses of layers and regions are exaggerated for clarity. It will also be understood that when a layer is referred to as being “on” another layer or substrate, the layer can be directly on the other layer or substrate, or intervening layers may also be present.

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

Various embodiments of the present general inventive concept set forth herein will be described based on a thermally driven inkjet printhead. However, the present general inventive concept can also be applied to a piezoelectric driven inkjet printhead. Also, the present general inventive concept can be applied to a monolithic type of inkjet printhead and a contact type of inkjet printhead. The drawings of the present application illustrate only a part of a silicon wafer, and the inkjet printhead according to the present general inventive concept can be manufactured in a form of tens to hundreds of chips on a single wafer.

A method of manufacturing an inkjet printhead according to an embodiment of the present general inventive concept includes forming, on a substrate, a heater to heat ink, and an electrode to supply a current to the heater; forming a channel forming layer to define an ink channel by coating a first negative photoresist composition on the substrate on which the heater and the electrode are formed and then patterning the coated composition using a photolithography process; forming a sacrificial layer on the substrate on which the channel forming layer is formed such that the sacrificial layer covers the channel forming layer; planarizing top surfaces of the channel forming layer and the sacrificial layer using a polishing process; forming a nozzle layer having a nozzle by coating a second negative photoresist composition on the channel forming layer and the sacrificial layer and patterning the coated composition using a photolithography process; forming an ink feed hole in the substrate; and removing the sacrificial layer, wherein the first and second negative photoresist compositions may be the same or different from each other, and each of the first and second negative photoresist compositions includes a prepolymer having a monomer repeating unit which has one of a glycidyl ether functional group, a ring-opened glycidyl ether functional group and an oxythane functional group, and one of a phenol novolac resin-based backbone, a bisphenol-A-based backbone, a bisphenol-F-based backbone, and an alicyclic-based backbone; a cationic photo initiator; a solvent; and an adhesion promoter.

The prepolymer included in the first and second negative photoresist compositions may be cross-linked when exposed to actinic radiation.

The prepolymer may be formed from a backbone monomer selected from the group consisting of phenol, o-crezole, ρ-crezole, bisphenol-A, an alicyclic compound, and a mixture thereof.

A prepolymer having the glycidyl ether functional group may be, but is not limited to, a prepolymer having a di-functional glycidyl ether functional group or a prepolymer having a multi-functional glycidyl ether functional group. These prepolymers will now be described in detail. First, the prepolymer having a di-functional glycidyl ether functional group may be a compound represented by Formula 1.

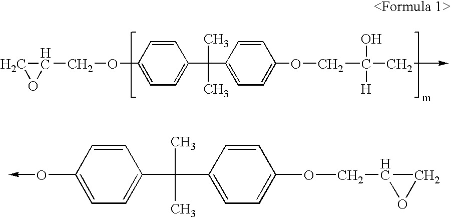

where m is an integer ranging from 1 to 20.

The prepolymer having a di-functional glycidyl ether functional group may form a film having a low crosslinkage density.

Examples of the prepolymer having a di-functional glycidyl ether functional group are EPON 828, EPON 1004, EPON 1001F, and EPON 1010 which are produced by Shell Chemical Co., Ltd; DER-332, DER-331, and DER-164 which are produced by Dow Chemical Co., Ltd; and ERL-4201 and ERL-4289 which are produced by Union Carbide Co., Ltd. However, the prepolymer having a di-functional glycidyl ether functional group is not limited to these products.

Examples of the prepolymer having a multi-functional glycidyl ether functional group are EPON SU-8 and EPON DPS-164 which are produced by Shell Chemical Co., Ltd; DEN-431 and DEN-439 which are produced by Dow Chemical Co., Ltd; and EHPE-3150 which is produced by Daicel Chemical Co., Ltd. However, the prepolymer having a multi-functional glycidyl ether functional group is not limited to these products.

In the prepolymer having a monomer repeating unit which has a glycidyl ether functional group and a phenol novolac resin-based backbone, a backbone monomer suitable for the phenol novolac resin may be phenol. The obtained compound may be represented by Formula 2.

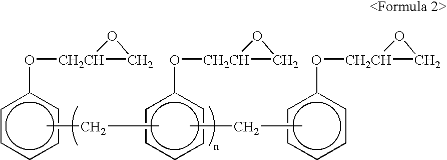

where n is an integer ranging from about 1 to 20, and specifically, from 1 to 10.

In the prepolymer having a monomer repeating unit which has a glycidyl ether functional group and a phenol novolac resin-based backbone, a backbone monomer suitable for the phenol novolac resin may also be a branched phenol, such as o-crezole or ρ-crezole. The obtained prepolymer may be represented by Formulae 3 or 4.

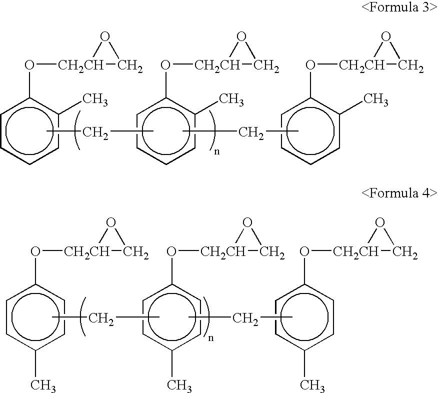

where n is an integer ranging from about 1 to 20, and specifically, from 1 to 10.

In the prepolymer having a monomer repeating unit which has a glycidyl ether functional group and a bisphenol-A-based backbone, a backbone monomer suitable for the phenol novolac resin may be bisphenol A. The obtained compound may be represented by Formulae 5 and 6:

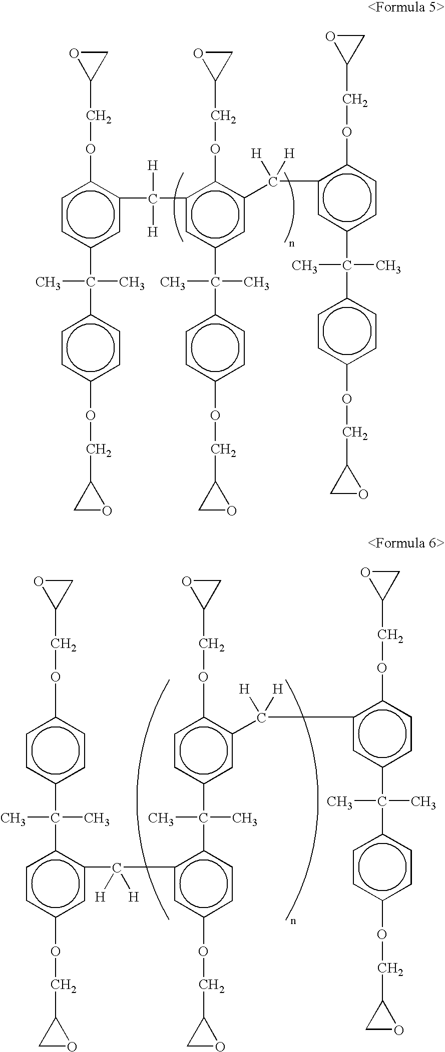

where n is an integer ranging from about 1 to 20, and specifically, from 1 to 10.

The prepolymer having a monomer repeating unit which has a glycidyl ether functional group and an alicyclic-based backbone may be represented by Formula 7. Specifically, examples of the prepolymer having a monomer repeating unit which has a glycidyl ether functional group and an alicyclic-based backbone are addition products of 1,2-epoxy-4(2-oxiranyl)-cyclohexane of 2,2-bis(hydroxy methyl)-1-butanol (product name: EHPH-3150]:

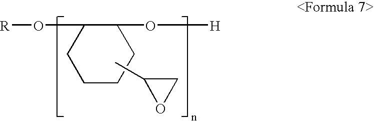

where n is an integer ranging from about 1 to 20, and specifically, from 1 to 10.

The prepolymer having a monomer repeating unit which has a glycidyl ether functional group and a bisphenol-F-based backbone may be represented by Formula 8:

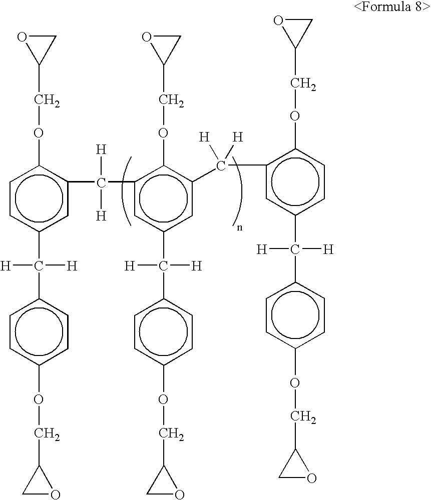

where n is an integer ranging from about 1 to 20, and specifically, from 1 to 10.

The prepolymer having a monomer repeating unit which has an oxythane functional group and a bisphenol-A-based backbone may be represented by Formula 9:

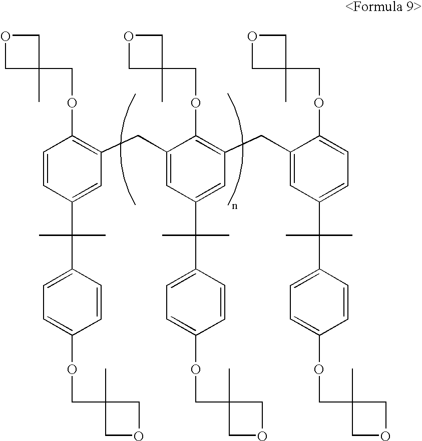

where n is an integer ranging from about 1 to 20, and specifically, from 1 to 10.

The prepolymer may include at least one compounds selected from the group consisting of the compounds represented by Formulae 1 to 9.

The cationic photo initiator included in each of the first and second negative photoresist compositions used in the present general inventive concept may be any material that generates an ion or a free radical that initiates a polymerization reaction when exposed to light. For example, such a material may be an aromatic halonium or sulfonium salt of Group VA or VI elements, such as UVI-6974 produced by Union Carbide Co. or SP-172 produced by Asahi denka.

The aromatic sulfonium salt may be triphenylsulfonium tetrafluoroborate, triphenylsulfonium hexafluoroantimonate (UVI-6974), phenylmethylbenzylsulfonium hexafluoroantimonate, phenylmethylbenzylsulfonium hexafluorophosphate, triphenylsulfonium hexafluorophosphate, methyl diphenylsulfonium tetrafluoroborate, or dimethyl phenylsulfonium hexafluorophosphate.

The aromatic halonium salt may be an aromatic iodonium salt. The aromatic iodonium salt may be, but is not limited to, diphenyliodonium tetrafluoroborate, diphenyliodonium hexafluoroantimonate, or butylphenyliodonium hexafluoroantimonate (SP-172).

The amount of the cationic photo initiator may be in a range of 1 to 10 parts by weight, specifically, 1.5 to 5 parts by weight, based on 100 parts by weight of the prepolymer. When the amount of the cationic photo initiator is less than 1 part by weight, a cross-linking reaction may insufficiently occur; alternatively, when the amount of the cationic photo initiator is greater than 10 parts by weight, a higher amount of light energy than light energy appropriate to a layer thickness is required, which thereby reduces the cross-linking speed.

The solvent included in each of the first and second negative photoresist compositions used in the present general inventive concept may include at least one compound selected from the group consisting of gamma-butyrolactone, propylene glycol methyl ethyl acetate, tetrahydrofurane, methyl ethyl ketone, methyl isobutyl ketone, cyclopentanone, and xylene.

The amount of the solvent may be in a range of 30 to 300 parts by weight, specifically, 50 to 200 parts by weight based on 100 parts by weight of the prepolymer. When the amount of the solvent is less than 30 parts by weight, the viscosity of the obtained polymer may be increased and processability may be degraded. Alternatively, when the amount of the solvent is greater than 300 parts by weight, the viscosity of the obtained polymer may be decreased and thus it may be difficult to form a pattern.

The adhesion promoter included in each of the first and second negative photoresist compositions used in the present general inventive concept may be represented by Formula 11.

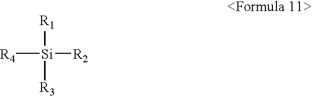

where R₁, R₂, R₃ and R₄ are each independently, hydrogen, halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

The adhesion promoter may be, but is not limited to, glycidoxypropyltrimethoxysilane, glycidoxypropylmethyldimethoxysilane, glycidoxypropyldimethylethoxysilane mercaptopropyltrimethoxysilane, γ-aminopropyltrimethoxysilane, γ-aminopropyltriethoxysilane, or N-(β-aminoethyl)-γ-aminopropyltrimethoxysilane.

The amount of the adhesion promoter may be in a range of 1 to 15 parts by weight, specifically, 5 to 10 parts by weight, based on 100 parts by weight of the prepolymer. When the amount of the adhesion promoter is less than 1 part by weight, the adhesion promoter may have little effect. Alternatively, when the amount of the adhesion promoter is greater than 15 parts by weight, the crosslinking density of the prepolymer may be lowered.

Each of the first and second negative photoresist compositions may further include other additives, such as a photo-accelerator, a silane coupling agent, a filler, a viscosity controller, a humidifier, or a photo stabilizer. The amount of such respective additives may be in a range of 0.1 to 20 parts by weight based on 100 parts by weight of the prepolymer.

The photo-accelerator may absorb light energy enabling easy energy delivery to another compound, which can be used to generate radical or ion initiators. The photo-accelerator may widen a wavelength range suitable for exposure. In general, the photo-accelerator may be an optical absorption chromophore included in an aromatic group. Also, the photo-accelerator may induce formation of a photo initiator which generates radicals or ions.

The terminology of “alkyl group” used in the present general inventive concept may refer to a linear or branched C₁-C₂₀ alkyl group including, for example, a linear or branched C₁-C₁₂ alkyl group, such as a linear or branched C₁-C₆ alkyl group. Such unsubstituted alkyl group may be methyl, ethyl, n-propyl, isopropyl, n-butyl, isobutyl, sec-butyl, t-butyl, pentyl, isoamyl, or hexyl. One or more hydrogen atoms included in such alkyl group may be substituted with a halogen atom, a hydroxyl group, —SH, a nitro group,

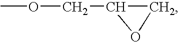

a cyano group, a substituted or unsubstituted amino group, such as —NH₂, —NH(R), or —N(R′)(R″) where R′ and R″ are each independently C₁-C₁₀ alkyl group, an amidino group, a hydrazine group, a hydrazone group, a carboxyl group, a sulfonic acid group, a phosphoric acid group, a C₁-C₂₀ alkyl group, a C₁-C₂₀ halogenated alkyl group, a C₁-C₂₀ alkenyl group, a C₁-C₂₀ alkynyl group, a C₁-C₂₀ heteroalkyl group, a C₆-C₂₀ aryl group, a C₆-C₂₀ arylalkyl group, a C₆-C₂₀ heteroaryl group, or a C₆-C₂₀ heteroarylalkyl group.

The term “alkoxy group” used in the present general inventive concept may refer to an oxygen-containing linear or branched alkoxy group having a C₁-C₂₀ alkyl moiety. The alkoxy group may include one to six carbon atoms, specifically, one to three carbon atoms. Examples of the alkoxy group are methoxy, ethoxy, propoxy, butoxy, and t-butoxy The alkoxy group may be further substituted with one or more halogen atoms, such as F, Cl, or Br to form a haloalkoxy group. Examples of the haloalkoxy group are fluoromethoxy, chloromethoxy, trifluoromethoxy, trifluoroethoxy, fluoroethoxy, and fluoropropoxy. One or more hydrogen atoms of the alkoxy group may be substituted with the substituents which have been described with reference to the alkyl group.

The term “alkenyl group” used in the present general inventive concept may refer to a linear or branched C₂-C₂₀ aliphatic hydrocarbon having a C—C double bond. A suitable alkenyl group may include 2 to 12 carbon atoms in a chain thereof, such as, for example, 2 to 6 carbon atoms in the chain thereof. Branched C₂-C₂₀ aliphatic hydrocarbon having a C—C double bond refers to a linear alkenyl chain to which one or more low alkyl or low alkenyl group are attached. Such an alkenyl group may not be substituted, or independently substituted with one or more groups selected from the group consisting of halo, carboxy, hydroxy, formyl, sulfur, sulfino, carbamoyl, amino and imino. In this regard, the substituent of the alkenyl group may not be limited to these groups. Such an alkenyl group may be ethenyl, prophenyl, carboxyethenyl, carboxyprophenyl, sulfinoethenyl or sulfonoethenyl. One or more hydrogen atoms of the alkenyl group may be substituted with the substituents which have been described with reference to the alkyl group.

The term “alkynyl group” used in the present general inventive concept may refer to a linear or branched C₂-C₂₀ aliphatic hydrocarbon group having a C—C triple bond. A suitable alkynyl group may include 2 to 12 carbon atoms in a chain thereof, such as, for example, 2 to 6 carbon atoms in the chain thereof. Branched C₂-C₂₀aliphatic hydrocarbon group having a C—C triple bond may refer to a linear alkynyl chain to which one or more low alkyl or low alkynyl groups are attached. Such an alkynyl group may not be substituted, or independently substituted with one or more groups selected from the group consisting of halo, carboxy, hydroxy, formyl, sulfur, sulfino, carbamoyl, amino and imino. In this regard, the substituents of the low alkenyl groups may not be limited to those groups. One or more hydrogen atoms of the alkynyl group may be substituted with the substituents which have been described with reference to the alkyl group.

The term “heteroalkyl group” used in the present general inventive concept may refer to a functional group in which a back bone of the alkyl group includes a hetero atom, such as N, O, P, or S. In this regard, the back bone of the alkyl group may include 1-20 carbons including, for example, 1-12 carbons, such as 1-6 carbons. One or more hydrogen atoms of the heteroalkyl group may be substituted with the substituents which have been described with reference to the alkyl group.

The term “aryl group” used in the present general inventive concept may refer to a C₆-C₃₀ carbocyclic aromatic system having one or more rings in which the rings are used alone or in combination. The rings may be attached or fused together using a pendent method. The term “aryl” refers to an aromatic radical, such as phenyl, naphthyl, tetrahydronaphthyl, indan, or biphenyl. For example, the aryl may be phenyl. One or more hydrogen atoms of the aryl group may be substituted with the substituents which have been described with reference to the alkyl group.

The term “arylalkyl group” used in the present general inventive concept may refer to an alkyl group that has one or more hydrogen atoms substituted with the aryl group.

The term “heteroaryl group” used in the present general inventive concept may refer to a monovalent monocyclic or the bicyclic aromatic radical having 5-30 ring atoms which consist of one, two, or three hetero atoms selected from N, O, and S, and carbons. In addition, the term refers to a monovalent cyclic or the bicyclic aromatic radical which forms, for example, N-oxide or a quaternary salt through oxidation or quanternization of a hetero atom in a chain thereof. Examples of the heteroaryl group are thienyl, benzothienyl, pyridyl, pyrazinyl, pyrimidinyl, pyridazinyl, quinolinyl, quinoxalinyl, imidazolyl, puranyl, benzopuranyl, thiazolyl, isoxazoline, benzisoxazoline, benzimidazolyl, triazolyl, pyrazolyl, pyrrolyl, indolyl, 2-pyridonyl, N-alkyl-2-pyridonyl, pyrazinonyl, pyridazinonyl, pyrimidinonyl, oxazolonyl, N-oxdies corresponding thereto, such as pyridyl N-oxide, quinolinyl N-oxide, and a quaternary salt thereof. One or more hydrogen atoms of the heteroaryl group may be substituted with the substituents which have been described with reference to the alkyl group.

The term “heteroarylalkyl group” used in the present general inventive concept may refer to a functional group prepared by substituting one or more hydrogen atom with the defined heteroaryl group. Specifically, the heteroarylalkyl group may refer to a C₃ to C₃₀ carbocycle aromatic system. One or more hydrogen atoms of the heteroarylalkyl group may be substituted with the substituents which have been described with reference to the alkyl group.

A method of manufacturing an inkjet printhead according to the present general inventive concept will now be described in detail. The method includes forming a heater to heat ink, and an electrode to supply a current to the heater, on a substrate; forming a channel forming layer to define an ink channel by coating a first negative photoresist composition on the substrate on which the heater and the electrode are formed and then patterning the coated composition using a photolithography process; forming a sacrificial layer on the substrate on which the channel forming layer is formed such that the sacrificial layer covers the channel forming layer; planarizing top surfaces of the channel forming layer and sacrificial layer using a polishing process; forming a nozzle layer having a nozzle by coating a second negative photoresist composition on the channel forming layer and the sacrificial layer and patterning the coated composition using a photolithography process; forming an ink feed hole in the substrate; and removing the sacrificial layer, wherein the first and second negative photoresist compositions may be the same or different from each other, and each of the first and second negative photoresist compositions includes a prepolymer having a monomer repeating unit which has one of a glycidyl ether functional group, a ring-opened glycidyl ether functional group and an oxythane functional group, and one of phenol novolac resin-based backbone, bisphenol-A-based backbone, bisphenol-F-based backbone, and alicyclic -based backbone; a cationic photo initiator; a solvent; and an adhesion promoter.

In the method, the substrate may be a silicon wafer.

In the method, the forming of a channel forming layer may include completely coating a first negative photoresist composition on a surface of the substrate to form a first photoresist layer; exposing the first photoresist layer using a first photomask having an ink channel pattern; and developing the first photoresist layer to remove the unexposed portion of the first photoresist layer so as to form the channel forming layer.

In the method, a glue layer to enhance an adhesive force between the substrate and the channel forming layer is not formed. That is, the channel forming layer is directly formed on the substrate. The method does not use a glue layer because a negative photoresist composition that is used to form the channel forming layer includes an adhesion promoter to improve an adhesive force of the channel forming layer with respect to the substrate. As a result, there is no need to coat the glue layer on the substrate, to form a mask to form a pattern, and to etch the glue layer. Thus, the manufacturing process can be simplified, and the manufacturing costs can be decreased.

In the method, the sacrificial layer may include a positive photoresist or a non-photosensitive soluble polymer. The positive photoresist may be imide-based positive photoresist, and the non-photosensitive soluble polymer may include at least one resin selected from the group consisting of phenol resin, poly urethane resin, epoxy resin, poly imide resin, acryl resin, poly amid resin, urea resin, melamine resin, and silicon resin. In this regard, the term ‘soluble’ refers to solubility with respect to a specific solvent.

In the forming of the sacrificial layer of the method, the sacrificial layer may be formed to have a greater thickness than the channel forming layer. The sacrificial layer may be formed by spin coating.

In the planarizing of the method, top portions of the channel forming layer and sacrificial layer may be planarized using a polishing process until the ink channel has a predetermined height. The polishing process may be a chemical-mechanical-polishing (CMP) process.

In the method, the forming of a nozzle layer may include coating the second negative photoresist composition on the channel forming layer and the sacrificial layer to form a second photoresist layer; exposing the second photoresist layer using a second photomask having a nozzle pattern; and developing the second photoresist layer to remove unexposed portions of the second photoresist layer so as to form a nozzle and a nozzle layer.

The forming of an ink feed hole may include coating photoresist on a bottom surface of the substrate; patterning the photoresist to form an etch mask to form the ink feed hole; and etching portions of the bottom surface of the substrate that are exposed through the etch mask to form the ink feed hole. In this regard, the bottom surface of the substrate may be etched using a dry etching method using plasma or a wet etching method using tetramethyl ammonium hydroxide (TMAH) or KOH as an etchant.

According to the present general inventive concept, a top surface of a sacrificial layer may be planarized and thus, a shape and dimensions of an ink channel may be easily controlled, and thus, uniformity of the ink channel can be improved.

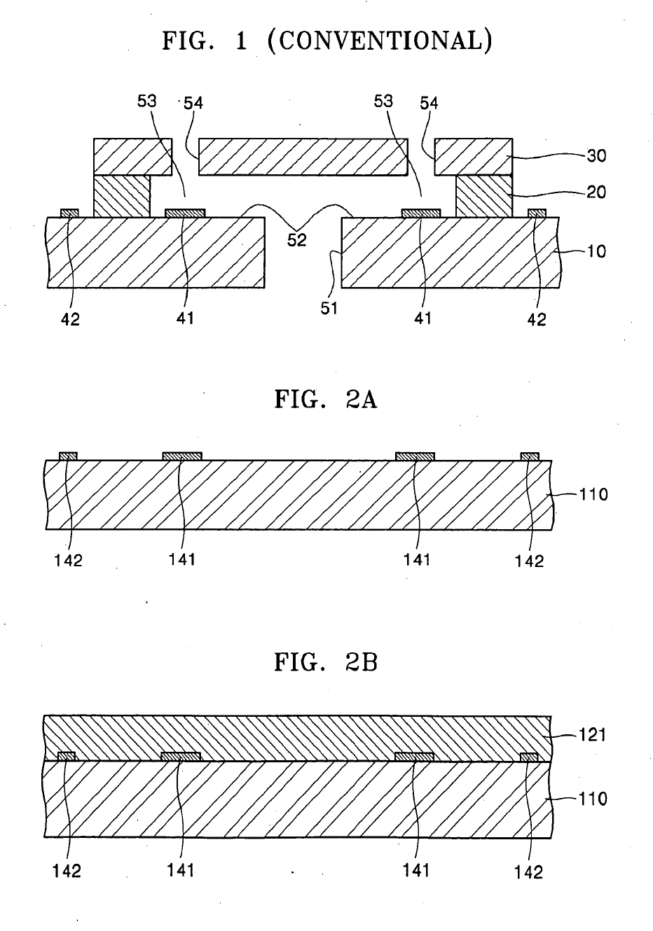

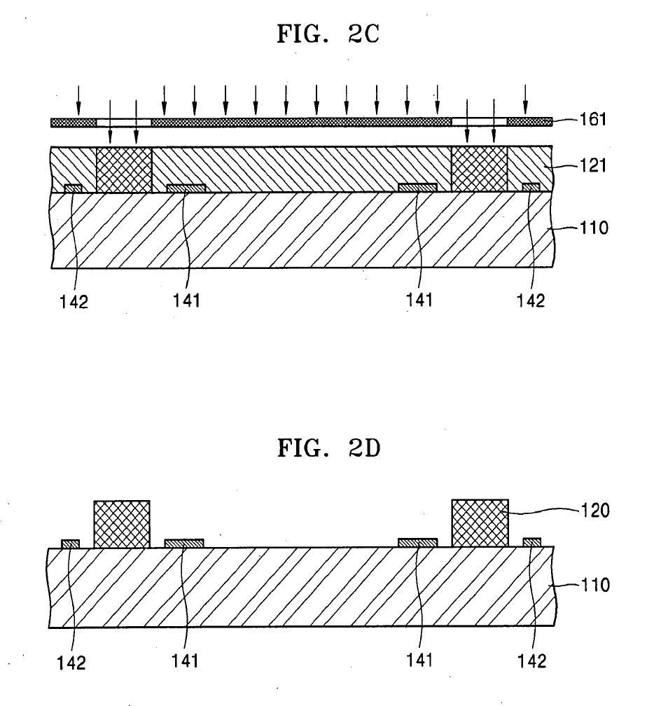

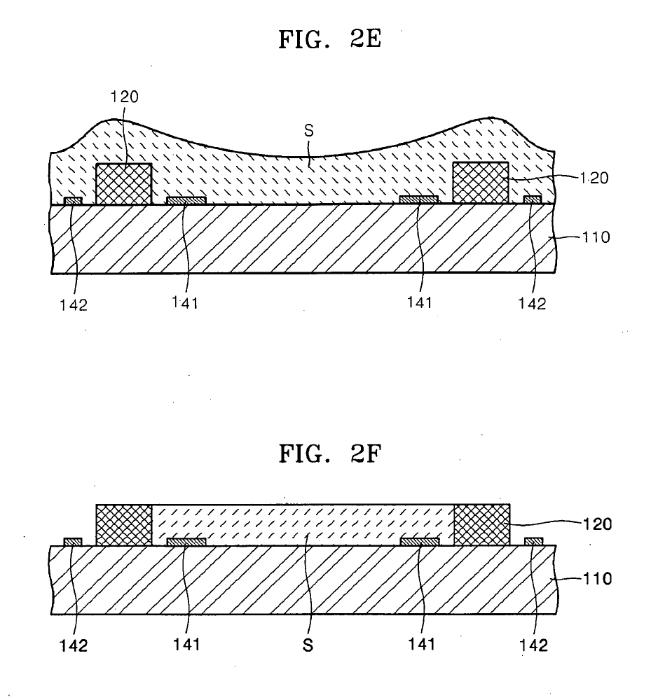

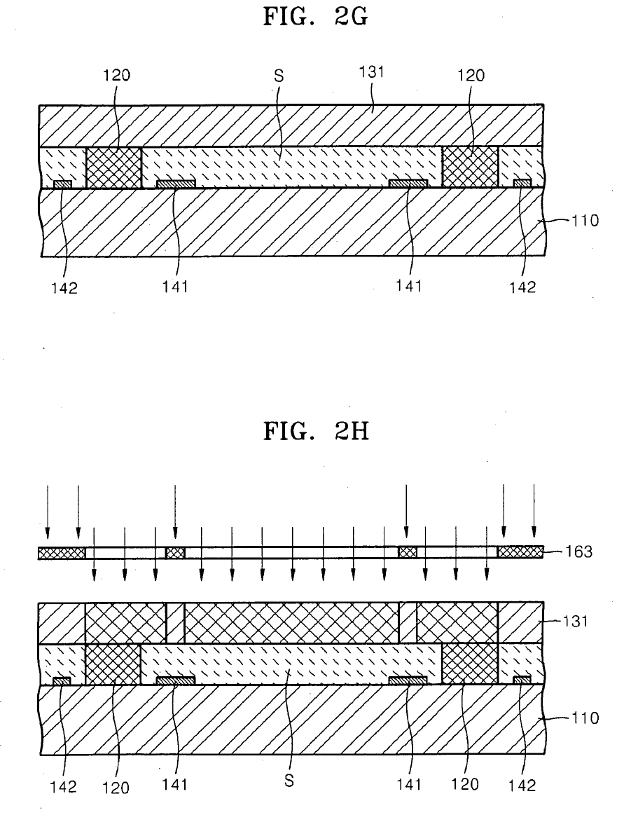

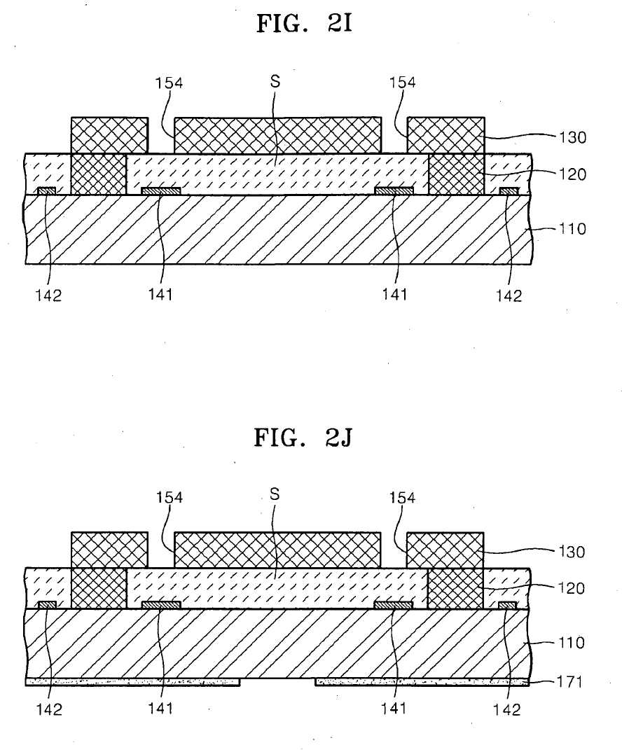

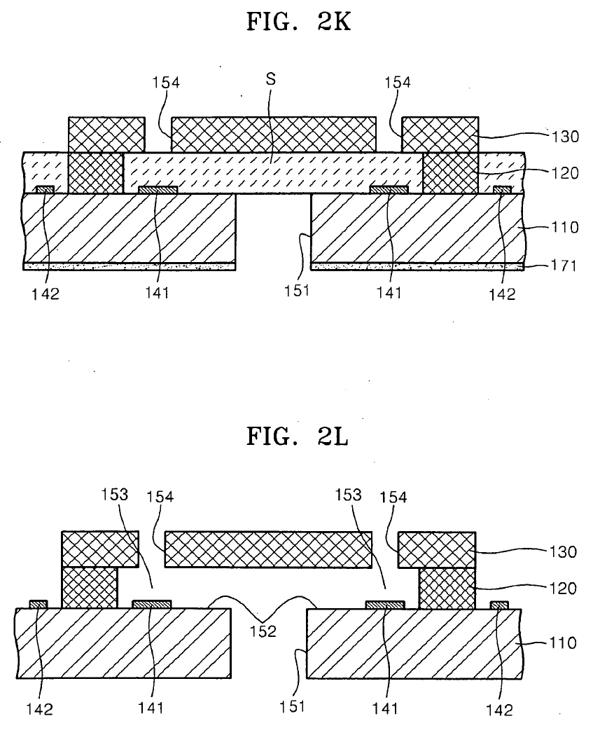

FIGS. 2A to 2I are sectional views illustrating a method of manufacturing an inkjet printhead, according to an embodiment of the present general inventive concept, in which a channel forming layer 120 and a nozzle layer 130 are formed using the first and second negative photoresist compositions having a prepolymer described above and a sacrificial layer S is planarized using a CMP process.

Referring to FIG. 2A, a heater 141 to heat ink, and an electrode 142 to supply a current to the heater 141 are formed on a substrate 110. In this regard, the substrate 110 may be a silicon wafer that is generally used in processes of manufacturing a semiconductor device, and is effective for mass production.

Specifically, the heater 141 is formed by depositing a resistance pyrogenic substance, such as a tantalum-nitride alloy or a tantalum-aluminum alloy, on the substrate 110 by using a sputtering method or a chemical vapor deposition method and then patterning the deposited material.

The electrode 142 is formed by depositing a conductive metal, such as aluminum or aluminum alloy, on the substrate 110 by using a sputtering method and then patterning the deposited material. Also, although not illustrated, a protective layer formed of silicon oxide or a silicon nitride may be formed on the heater 141 and the electrode 142.

Then, referring to FIG. 2B, a first negative photoresist layer 121 is formed on the substrate 110 on which the heater 141 and the electrode 142 are formed. The first negative photoresist layer 121 may be used to form the channel forming layer 120 (refer to FIG. 2D) which defines an ink chamber and a restrictor, as will be described in detail later. The first negative photoresist layer 121 is cross-linked when exposed to actinic radiation, such as UV radiation, and thus, the first negative photoresist layer 121 is chemically stabilized with respect to ink. The first negative photoresist layer 121 may be formed using the first negative photoresist composition including the prepolymer described above. Specifically, the first negative photoresist layer 121 is formed by completely coating the first negative photoresist composition on the surface of substrate 110 to a predetermined thickness using a spin coating method.

Then, referring to FIG. 2C, the first negative photoresist layer 121 is exposed to actinic radiation, such as UV radiation, using a first photomask 161 which has an ink chamber pattern and a restrictor pattern. In the exposing process, a portion of the first negative photoresist layer 121 that is exposed to UV radiation is hardened and thus has chemical durability and a high mechanical strength, alternatively, a portion of the first negative photoresist layer 121 that is not exposed to UV radiation is easily dissolved by a developer.

Then, the first negative photoresist layer 121 is developed to remove the unexposed portion of the first negative photoresist layer 121 so as to form the channel forming layer 120 to define an ink channel, as illustrated in FIG. 2D.

Then, referring to FIG. 2E, a sacrificial layer S is formed on the substrate 110 such that the sacrificial layer S covers the channel forming layer 120. In this regard, the sacrificial layer S may be formed to have a greater thickness than the channel forming layer 120, and may be formed by spin-coating a positive photoresist composition or a non-photosensitive soluble polymer composition on the substrate 110 to a predetermined thickness. The positive photoresist may be imide-based positive photoresist. When the sacrificial layer S includes the imide-based positive photoresist, the sacrificial layer S may not be affected by the solvent, and even when exposed to light, nitrogen gas is not generated. After the spin coating, the imide-based positive photoresist is hard baked at about 140° C. Alternatively, the sacrificial layer S can be formed by spin coating the non-photosensitive soluble polymer in a liquid state on the substrate 110 to a predetermined thickness and then baking the coated product. In this regard, the non-photosensitive soluble polymer may include at least one resin selected from the group consisting of phenol resin, poly urethane resin, epoxy resin, poly imide resin, acryl resin, poly amid resin, urea resin, melamine resin, and silicon resin.

Then, referring to FIG. 2F, top surfaces of the channel forming layer 120 and sacrificial layer S are planarized by CMP Specifically, top portions of the sacrificial layer S and channel forming layer 120 are polished by CMP until the ink channel has a predetermined height, and thus, the channel forming layer 120 and the sacrificial layer S have the same thickness.

Then, referring to FIG. 2G, a second negative photoresist layer 131 is formed on the planarized top surfaces of the channel forming layer 120 and the sacrificial layer S. Like the first negative photoresist layer 121, the second negative photoresist layer 131 can be formed using a second negative photoresist composition having the monomer repeating unit which has one of a glycidyl ether functional group, a ring-opened glycidyl ether functional group and a oxythane functional group, and one of a phenol novolac resin-based backbone, a bisphenol-A-based backbone, a bisphenol-F-based backbone and an alicyclic-based backbone.

The second negative photoresist layer 131 is used to form the nozzle layer 130 (refer to FIG. 2I), as described later. The second negative photoresist layer 131 is cross-linked when exposed to actinic radiation, such as UV radiation, and thus becomes chemically stabilized with respect to ink. Specifically, the second negative photoresist layer 131 is formed by coating the second negative photoresist composition on the channel forming layer 120 and the sacrificial layer S to a predetermined thickness by using a spin coating method. In this regard, the second negative photoresist layer 131 may be formed to such a thickness that a nozzle 154 has an appropriate depth and the nozzle layer 130 can endure a change in pressure in the ink chamber.

In addition, since the top surfaces of the sacrificial layer S and the channel forming layer 120 are planarized to be flush with each other in the previous process, deformation or melting of an edge portion of the sacrificial layer S due to a reaction between a material forming the second negative photoresist layer 131 and a material forming the sacrificial layer S may not occur. Therefore, the second photoresist layer 131 can be adhered to the top surface of the channel forming layer 120.

Then, referring to FIG. 2H, the second negative photoresist layer 131 is exposed using a second photomask 163 having a nozzle pattern. Then, the second negative photoresist layer 131 is developed such that a non-exposed portion of the second negative photoresist layer 131 is removed to form a nozzle 154 as illustrated in FIG. 2I and a portion that is exposed and hardened remains as the nozzle layer 130. When the sacrificial layer S includes imide-based positive photoresist as described above, nitrogen gas is not generated even when the sacrificial layer S is exposed through second negative photoresist layer 131. Therefore, deformation of the nozzle layer 130 by the generated nitrogen gas does not occur.

Then, referring to FIG. 2J, an etch mask 171 to form an ink feed hole (151 of FIG. 2K) is formed on a bottom surface of the substrate 110. For example, the etch mask 171 can be formed by coating a positive or negative photoresist on the bottom surface of the substrate 110 and then patterning the resultant photoresist into the etch mask 171.

Then, referring to FIG. 2K, a portion of the bottom surface of the substrate 110, which is exposed by the etch mask 171, is etched to form a through-hole in the substrate 110, thereby forming an ink feed hole 151, and then, the etch mask 171 is removed. Such etching on the bottom surface of the substrate 110 can be performed using a dry etching method using plasma. Alternatively, such etching on the bottom surface of the substrate 110 can be performed using a wet etching method which employs tetramethyl ammonium hydroxide (TMAH) or KOH as an etchant. Finally, the sacrificial layer S is removed using a solvent so that an ink chamber 153 surrounded by the channel forming layer 120 and a restrictor 152 is formed and the electrodes of the electrode pattern 142 to supply a current to the heater 141 is exposed. Therefore, the inkjet printhead, as illustrated in FIG. 2L, is completely manufactured.

The present general inventive concept will be described in further detail with reference to the following examples. These examples are for illustrative purposes only and are not intended to limit the scope of the present general inventive concept.

### PREPARATION EXAMPLE 1

### Preparation of Negative Photoresist Composition

30 g of xylene (produced by Samchun Chemical Co.), 2 g of glycidoxypropyltrimethoxysilane (produced by Sigma-Aldrich), and 2 g of SP-172 (produced by Asahi Denka Korea Chemical Co.) were added to a jar to prepare a resist solution. Then, 40 g of EPON SU-8 (produced by Shell Chemical Co.) was added to the jar, and then the resultant solution was mixed using an impeller for about 24 hours, thereby preparing a negative photoresist composition.

### EXAMPLE 1

A tantalum nitride heater pattern 141 having a thickness of about 500 Å and an electrode pattern 142 formed of an AlSiCu alloy (Si and Cu each in an amount of 1 wt. % or less) having a thickness of about 500 Å were formed on a 6-inch silicon wafer 110 using a conventional sputtering process and a photolithography process (see FIG. 2A).

Then, as illustrated in FIG. 2B, the negative photoresist composition prepared according to Preparation Example 1 was spin coated on the surface of the substrate (silicon wafer) 110 on which the tantalum nitride heater pattern 141 and the electrode pattern 142 were formed, with a rotation speed of 2000 rpm for 40 seconds, and then baked at 95° C. for 7 minutes to form a first negative photoresist layer 141 having a thickness of about 10 μm. Then, as illustrated in FIG. 2C, the first negative photoresist layer 141 was exposed to i-line UV light using a first photomask 161 having a predetermined ink chamber pattern and a restrictor pattern. In this regard, the amount of the i-line UV light was adjusted to 130 mJ/cm2 during the exposure. The resultant wafer was baked at 95° C. for 3 minutes, dipped in a PGMEA developer for one minute, and then rinsed with isopropanol for 20 seconds. As a result, a channel forming layer 120 was completely formed (refer to FIG. 2D.)

Then, as illustrated in FIG. 2E, imide-based positive photoresist (manufacturer: TORAY, product name: PW-1270) was spin-coated on the entire surface of the wafer on which the channel forming layer 120 was formed, with a rotation speed of 1000 rpm for 40 seconds, and then baked at about 140° C. for 10 minutes to form a sacrificial layer S. The formation of the sacrificial layer S was controlled such that a thickness of a portion of the sacrificial layer S on the channel forming layer 120 was about 5 μm.

Then, a CMP process was performed to planarize top surfaces of the channel forming layer 120 and the sacrificial layer S, as illustrated in FIG. 2F. Specifically, the resultant wafer was provided to a polishing pad such that the sacrificial layer S faced the polishing pad of a polishing plate (manufacturer: JSR, Product No. JSR FP 8000.) Then, the wafer on the polishing pad was pressed by applying a pressure of 10 to 15 kPa to a backing pad by a press head. While a polishing slurry (FUJIMI Corporation, POLIPLA 103) was being fed onto the polishing pad, the press head was rotated with respect to the polishing pad at a speed of 40 rpm. The backing pad was formed of a material having a shore D hardness of 30 to 70. The sacrificial layer S was removed at an etch rate of 5 to 7 μm/min until a top portion of the channel forming layer 120 was removed by about 1 μm, so as to planarize the channel forming layer 120.

The negative photoresist composition prepared according to Preparation Example 1 and a second photomask 163 were used to form a nozzle layer pattern 130 on the silicon wafer 110 on which the channel forming layer 120 and the sacrificial layer S were formed using the same conditions as when the channel forming layer 120 was formed (see FIGS. 2G, 2H, and 2I.)

As illustrated in FIG. 2J, an etch mask 171 was formed on a bottom surface of the silicon wafer 110 using a conventional photolithography method of forming an ink feed hole 151. Then, as illustrated in FIG. 2K, a portion of the bottom surface of the silicon wafer 110, which was exposed by the etch mask 171, was etched by plasma etching to form the ink feed hole 151, and then the etch mask 171 was removed. In this regard, the power of a plasma etching apparatus used was 2000 Watts, an etch gas was a gaseous mixture of SF6 and O2 in a mixture ratio of 10:1, and an etch speed applied to the silicon wafer 110 was 3.7 μm/min.

Finally, the wafer was dipped in a methyl lactate solvent for 2 hours to remove the sacrificial layer S and thereby form an ink chamber 153 and a restrictor 152 as defined by the channel forming layer 120 (see FIG. 2L.) At this point manufacture of an inkjet printhead having a structure as illustrated in FIG. 2L was completed.

As described above, an inkjet printhead was manufactured using the negative photoresist composition prepared according to Preparation Example 1 as the first negative photoresist composition and the second negative photoresist composition.

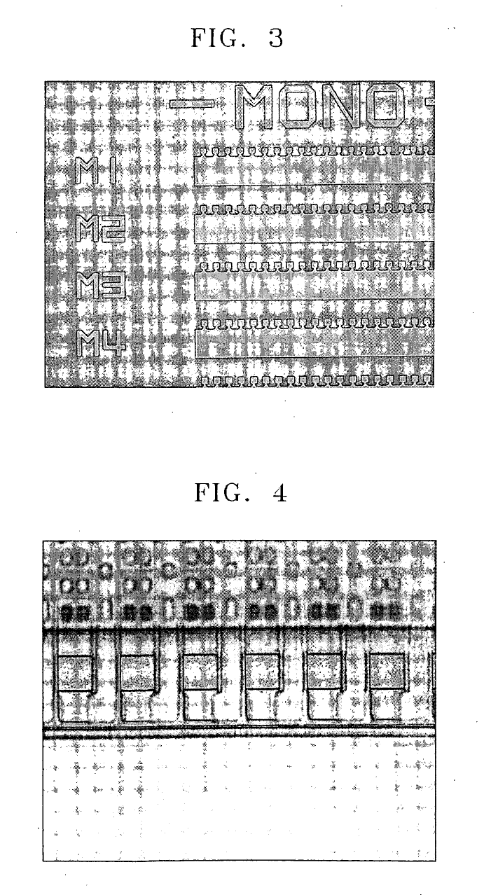

FIG. 3 illustrates a pattern formed using the negative photoresist composition employed in an inkjet printhead according to the present general inventive concept on a silicon substrate, and FIG. 4 is an optical microscopic image of a pattern of a channel forming layer on a main substrate.

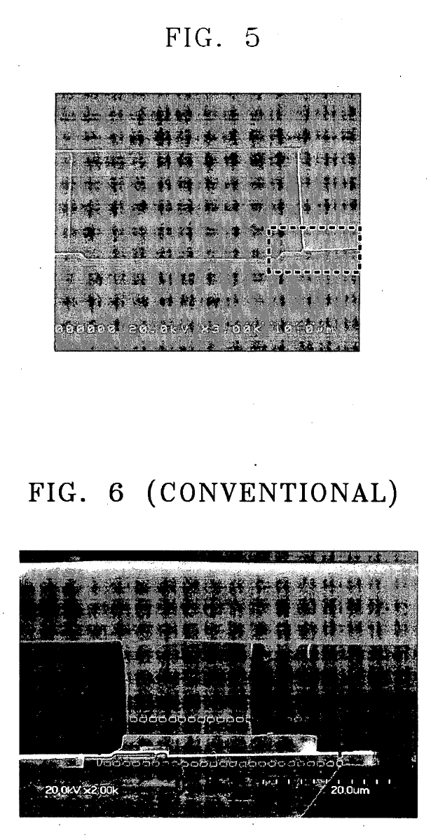

FIG. 5 illustrates a scanning electron microscopic (SEM) image of a cross section of a channel forming layer of an inkjet printhead according to an embodiment of the present general inventive concept, and FIG. 6 illustrates a SEM image of a cross section of a channel forming layer of a conventional inkjet printhead including a glue layer.

Referring the dotted lines of FIGS. 5 and 6, it can be seen that in a conventional inkjet printhead, a glue layer is formed between a substrate and a channel forming layer (see FIG. 6); and alternatively, in the inkjet printhead according to an embodiment of the present general inventive concept, the channel forming layer is directly disposed on a substrate (see FIG. 5) and a glue layer is not used.

While the present general inventive concept has been particularly illustrated and described with reference to exemplary embodiments thereof, it will be understood by those of ordinary skill in the art that various changes in form and details may be made therein without departing from the spirit and scope of the present general inventive concept as defined by the following claims.

What is claimed is:

1. A method of manufacturing an inkjet printhead, the method comprising:
forming, on a substrate, a heater to heat ink, and an electrode to supply a current to the heater;
forming a channel forming layer to define an ink channel by coating a first negative photoresist composition on the substrate on which the heater and the electrode are formed and then patterning the coated composition using a photolithography process;
forming a sacrificial layer on the substrate on which the channel forming layer is formed such that the sacrificial layer covers the channel forming layer;
planarizing top surfaces of the channel forming layer and sacrificial layer using a polishing process;
forming a nozzle layer having a nozzle by coating a second negative photoresist composition on the channel forming layer and the sacrificial layer and patterning the coated composition using a photolithography process;
forming an ink feed hole in the substrate; and
removing the sacrificial layer,
wherein each of the first and second negative photoresist compositions comprises:
a prepolymer having a monomer repeating unit which has one of a glycidyl ether functional group, a ring-opened glycidyl ether functional group and an oxythane functional group, and one of phenol novolac resin-based backbone, bisphenol-A-based backbone, bisphenol-F-based backbone, and alicyclic backbone;
a cationic photo initiator;
a solvent; and
an adhesion promoter.

2. The method of claim 1, wherein the polishing process is a chemical mechanical polishing (CMP) process.

3. The method of claim 1, wherein the substrate comprises:
a silicon wafer.

4. The method of claim 1, wherein the forming of the channel forming layer comprises:
completely coating the first negative photoresist composition on a surface of the substrate to form a first photoresist layer;
exposing the first photoresist layer using a first photomask having an ink channel pattern; and
developing the first photoresist layer to remove the unexposed portion of the first photoresist layer so as to form the channel forming layer.

5. The method of claim 1, wherein the sacrificial layer comprises:
a positive photoresist or a non-photosensitive soluble polymer.

6. The method of claim 1, wherein the positive photoresist is an imide-based positive photoresist.

7. The method of claim 5, wherein the non-photosensitive soluble polymer comprises:
at least one resin selected from the group consisting of phenol resin, poly urethane resin, epoxy resin, poly imide resin, acryl resin, poly amid resin, urea resin, melamine resin, and silicon resin.

8. The method of claim 1, wherein, in the forming of the sacrificial layer, the sacrificial layer is formed to have a greater thickness than the channel forming layer.

9. The method of claim 1, wherein, in the forming of the sacrificial layer, the sacrificial layer is formed by spin coating.

10. The method of claim 1, wherein, in the planarizing, the top surfaces of the channel forming layer and the sacrificial layer are polished until the ink channel has a predetermined height.

11. The method of claim 1, wherein the forming the nozzle layer comprises:
coating the second negative photoresist composition on the channel forming layer and the sacrificial layer to form a second photoresist layer;
exposing the second photoresist layer using a second photomask having a nozzle pattern; and
developing the second photoresist layer to remove an unexposed portion of the second photoresist layer so as to form a nozzle and a nozzle layer.

12. The method of claim 1, wherein the forming of the ink feed hole comprises:
coating photoresist on a bottom surface of the substrate;
patterning the photoresist to form an etch mask that is used to form the ink feed hole; and
etching a portion of the bottom surface of the substrate that is exposed by the etch mask so as to form an ink feed hole.

13. The method of claim 12, wherein the bottom surface of the substrate is dry-etched using plasma.

14. The method of claim 12, wherein the bottom surface of the substrate is wet-etched using tetramethyl ammonium hydroxide (TMAH) or KOH as an etchant.

15. The method of claim 1, wherein each of the first and second negative photoresist compositions comprises:
1 to 10 parts by weight of the cationic photo initiator, 30 to 300 parts by weight of the solvent, and 1 to 15 parts by weight of the adhesion promoter, based on 100 parts by weight of the prepolymer.

16. The method of claim 1, wherein the prepolymer is formed from a backbone monomer selected from the group consisting of phenol, o-crezole, p-crezole, bisphenol-A, an alicyclic compound, and a mixture thereof.

17. The method of claim 1, wherein the prepolymer comprises:
one or more compounds selected from the group consisting of compounds represented by Formulae 1 to 9: 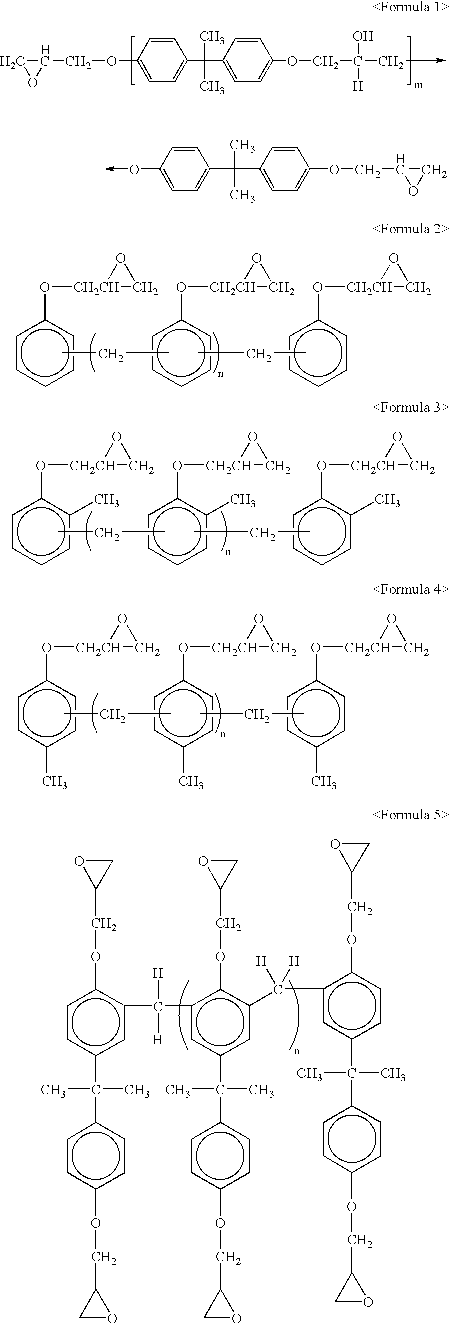 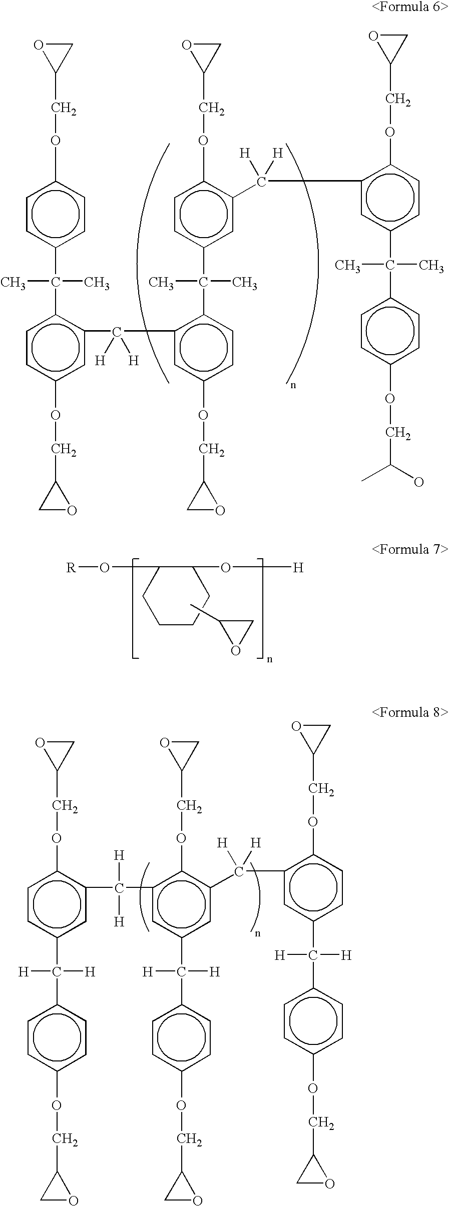 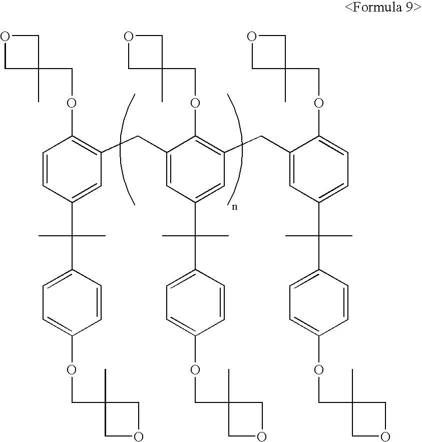
where m is an integer ranging from 1 to 20, and n is an integer ranging from 1 to 20.

18. The method of claim 1, wherein the cationic photo initiator may be sulfonium salt or iodonium salt.

19. The method of claim 1, wherein the solvent comprises:
at least one compound selected from the group consisting of γ-butyrolactone, propylene glycol methyl ethyl acetate (PGMEA), tetrahydrofurane (THF), methyl ethyl ketone, methyl isobutyl ketone, cyclopentanone, and a mixture thereof.

20. The method of claim 1, wherein the adhesion promoter is represented by Formula 10: 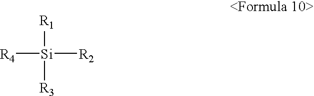
where R₁, R₂, R₃ and R₄ are each independently, hydrogen, halogen atom, a carboxyl group, an amino group, a nitro group, a cyano group, a substituted or unsubstituted C₁-C₂₀ alkyl group, a substituted or unsubstituted C₁-C₂₀ alkoxy group, a substituted or unsubstituted C₂-C₂₀ alkenyl group, a substituted or unsubstituted C₂-C₂₀ alkynyl group, a substituted or unsubstituted C₁-C₂₀ heteroalkyl group, a substituted or unsubstituted C₆-C₃₀ aryl group, a substituted or unsubstituted C₇-C₃₀ arylalkyl group, a substituted or unsubstituted C₅-C₃₀ heteroaryl group, or a substituted or unsubstituted C₃-C₃₀ heteroarylalkyl group.

21. The method of claim 1, wherein the adhesion promoter comprises:
at least one compound selected from the group consisting of glycidoxypropyltrimethoxysilane, glycidoxypropylmethyldimethoxysilane, glycidoxypropyldimethylethoxysilane mercaptopropyltrimethoxysilane, γ-aminopropyltrimethoxysilane, γ-aminopropyltriethoxysilane, and N-(β-aminoethyl)-γ-aminopropyltrimethoxysilane.

22. An inkjet printhead, comprising:
a substrate; and
a channel forming layer directly formed on the substrate without a glue layer formed therebetween,
wherein a negative photoresist composition having an adhesion promoter to improve an adhesive force of the channel forming layer with respect to the substrate is used to form the channel forming layer.

23. A method of manufacturing an inkjet printhead, the method comprising:
forming a channel forming layer on a substrate to define an ink channel by coating a first negative photoresist composition on the substrate; and
forming a nozzle layer having a nozzle by coating a second negative photoresist composition on the channel forming layer,
wherein each of the first and second negative photoresist compositions includes an adhesive promoter so that a glue layer is not used between the substrate and the channel forming layer.
